(19) United States
(12) Patent Application Publication
(10) Pub. No.: US 2025/0304158 A1
(43) Pub. Date: Oct. 2, 2025

(54) VEHICLE CONTROLLER AND CONTROL METHOD

(71) Applicant: JAGUAR LAND ROVER LIMITED, Warwickshire (GB)

(72) Inventors: Bhavika Soni, Whitley, Coventry, Warwickshire (GB); Ian Tilford, Whitley, Coventry, Warwickshire (GB)

(21) Appl. No.: 18/864,125

(22) PCT Filed: May 5, 2023
(86) PCT No.: PCT/EP2023/061998

§ 371 Date: Nov. 8, 2024

(30) Foreign Application Priority Data
May 9, 2022 (GB) 2206754.0

(51) Int. Cl. B62D 6/02

(52) U.S. Cl. CPC B62D 6/02

(57) ABSTRACT

Aspects of the present invention relate to a control system for controlling a rear wheel steering system of a vehicle. The control system is configured to receive first, second and third input signals indicative of vehicle speed, requested actuator displacement, and actual actuator displacement. The control system determines the magnitude of the difference between the requested actuator displacement and the actual actuator displacement. If the vehicle speed is zero, and the magnitude of the difference between the requested actuator displacement and the actual actuator displacement is greater than or equal to a first threshold and less than or equal to a second threshold, the control system outputs an instruction to move a rear wheel steering actuator to a position where the difference between the requested actuator displacement and the actual actuator displacement is zero. Aspects of the present invention also relate to a method, a system, a vehicle, and computer software and hardware for controlling a rear wheel steering system.

### TECHNICAL FIELD

The present disclosure relates to a vehicle controller and control method and particularly, but not exclusively, to a controller and a method for controlling a rear wheel steering system of a vehicle. Aspects of the invention relate to a control system, to a system comprising the control system, to a method, to a vehicle comprising the control system and/or system, to computer software arranged to perform the method, and to a non-transitory computer-readable storage medium storing instructions to carry out the method.

### BACKGROUND

It is known to provide road going vehicles with a front wheel steering system which typically comprises a driver operated steering wheel connected by a pinion gear to a steering rack which controls the angular position of the front road wheels of the vehicle, thereby controlling the direction in which the vehicle steers in both the forward and reverse directions. The angular position of the front road wheels may be referred to as the ‘front road wheel steering angle’ which is the angle between each front road wheel and a straight-ahead position, at which the road wheel is aligned with the vehicle.

Recently, rear wheel steering (which is used in combination with front wheel steering) has become popular as it can be used to provide improved low speed manoeuvrability and high speed vehicle stability. Rear wheel steering systems commonly use a drive-by-wire system in which steering inputs made by the driver via the steering wheel are converted to electronic signals which are relayed, via a control system, to a motor driven actuator which controls the angular position of the rear road wheels of the vehicle, thereby providing rear wheel steering functionality. The angular position of the rear road wheels may be referred to as the ‘rear road wheel steering angle’ which is the angle between each rear road wheel and a straight-ahead position, at which the road wheel is aligned with the vehicle.

The rear road wheel steering angles are typically less than the front road wheel steering angles and it is the combination of the front and rear road wheel steering angles that determines the direction in which the vehicle steers. Front and rear wheel steering systems are typically configured so that the road wheel steering angles are not the same on each side of the vehicle to avoid scrub on the faster or slower rotating wheel.

The rear road wheel steering angle is typically determined by the control system in dependence on a number of factors including the steering input from the driver and the speed of the vehicle. Vehicle speed is typically obtained by measuring the speed of rotation of one or more of the wheels and using this measurement to determine a vehicle speed. In some driving conditions, such as driving on ice or mud for example, the vehicle may slide due to lack of friction between the tyres and the road or other driving surface. In these circumstances the vehicle may have a linear speed while one or more of the wheels are not rotating. This can cause the determined vehicle speed to be incorrect and in some cases read as zero. At other times it is possible for the vehicle speed signal to be missing such that the rear wheel steering control system has no speed input signal at all. In this case, the control system assumes that the vehicle speed is zero. This might happen, for example, if there are problems experienced in the signal communication network. In such cases, the rear wheel control system either does not have a correct speed input or has no speed input at all.

In order to conserve energy, it is common for rear wheel drive systems to be configured such that no power is supplied to the motor driven actuator of the rear wheel drive system when the vehicle speed is zero. In such systems, if the speed signal erroneously reads zero, or is missing, no power is supplied to the motor driven actuator meaning that the rear road wheel steering angle is not controlled and may change as a result of the vehicle's continued motion during the time that the speed signal is incorrect or missing, a behaviour known as ‘backdrive’.

Once the vehicle has stopped sliding and the true vehicle speed is available, or the speed signal is once again available from the signal communication network, the rear wheel steering control system again receives all of the inputs required to determine the rear wheel rear road wheel steering angle. However, for the time that the vehicle speed read zero due to sliding, or for the time that the vehicle speed signal was missing, the rear wheels could have been moving away from their expected position due to ‘backdrive’. This can cause the driver to experience unexpected steering feel once the rear wheel steering control system resumes operation with a correct, or available, speed input signal.

### SUMMARY OF THE INVENTION

It is an aim of the present invention to address one or more of the disadvantages associated with the prior art.

Aspects and embodiments of the invention provide a control system, a system, a method, a vehicle, computer software and a and non-transitory, computer-readable storage medium as claimed in the appended claims.

According to an aspect of the present invention there is provided a control system for controlling an actuator of a rear wheel steering system of a vehicle, the control system comprising one or more controllers, the control system configured to: receive a first input signal indicative of vehicle speed and determine a vehicle speed in dependence on the first input signal; receive a second input signal indicative of a requested actuator displacement; receive a third input signal indicative of an actual actuator displacement; determine, in dependence on the second input signal and the third input signal, the magnitude of the difference between the requested actuator displacement and the actual actuator displacement; and output a signal comprising an instruction to move the actuator to a position in which the difference between the requested actuator displacement and the actual actuator displacement is zero if: the determined vehicle speed is zero; and the magnitude of the difference between the requested actuator displacement and the actual actuator displacement is determined to be greater than or equal to a first threshold value and less than or equal to a second threshold value.

The present invention is advantageous as control of the rear wheel steering system is maintained even if the vehicle speed signal erroneously reads zero. Suitable steering feel is maintained by controlling the rear wheel steering system to move to the requested actuator displacement when it is appropriate to do so. Whether or not it is appropriate being determined with reference to tuneable upper and lower thresholds of the magnitude of the difference between the requested actuator displacement and the actual actuator displacement.

In an embodiment, the one or more controllers collectively comprise: at least one electronic processor having an electrical input for receiving one or more of the first, second, and/or third input signals; and at least one memory device electrically coupled to the at least one electronic processor and having instructions stored therein; and wherein the at least one electronic processor is configured to access the at least one memory device and execute the instructions thereon so as to: determine the vehicle speed; determine the magnitude of the difference between the requested actuator displacement and the actual actuator displacement; and output the signal comprising the instruction in dependence on the vehicle speed and the magnitude of the difference between the requested actuator displacement and the actual actuator displacement.

Optionally, the control system may be configured to determine a vehicle speed equal to zero if the first input signal is unavailable. This allows the above mentioned advantages to be realised when the speed input signal is missing.

The control system may optionally be configured to: output a signal comprising an instruction to hold the actuator at its current displacement if: the determined vehicle speed is zero; and the magnitude of the difference between the requested actuator displacement and the actual actuator displacement is determined to be greater than the second threshold value. This advantageously prevents sudden changes in steering which may be felt by the driver if the magnitude of the difference between the requested actuator displacement and the actual actuator displacement is above an acceptable threshold.

The control system may be configured to: output a signal comprising an instruction to hold the actuator at its current displacement if: the determined vehicle speed is zero; and the magnitude of the difference between the requested actuator displacement and the actual actuator displacement is determined to be less than the first threshold value. This advantageously prevents unnecessary movement of the rear wheel steering actuator when the magnitude of the difference between the requested actuator displacement and the actual actuator displacement is below a threshold which may be determined with reference to the accuracy id the actual actuator displacement signal.

According to another aspect of the invention, there is provided a system, comprising: an actuator having a moveable actuator element, wherein displacement of the actuator element from a home position determines a steering position of the rear wheel steering system; and the control system of any preceding claim, including at least a first controller, wherein the at least a first controller is arranged to output a signal for causing movement of the actuator element, wherein the actuator is configured to receive the signal and move the actuator element in dependence on the signal.

According to still another aspect of the invention, there is provided a method for controlling an actuator of a rear wheel steering system of a vehicle, the method comprising: receiving a signal indicative of vehicle speed and determining a vehicle speed in dependence on the signal indicative of vehicle speed; receiving a displacement request signal indicative of a requested actuator displacement; receiving an actuator displacement signal indicative of an actual actuator displacement; determining, in dependence on the displacement request signal and the actuator displacement signal, the magnitude of the difference between the requested actuator displacement and the actual actuator displacement; and moving the actuator until the difference between the requested actuator displacement and the actual actuator displacement is zero if: if the determined vehicle speed is zero; and the magnitude of the difference between the requested actuator displacement and the actual actuator displacement is greater than or equal to a first threshold value and less than or equal to a second threshold value.

Optionally the method comprises determining that the vehicle speed is equal zero if the first input signal is unavailable.

The method may optionally comprise: holding the actuator at its current displacement if: the determined vehicle speed is zero; and the magnitude of the difference between the requested actuator displacement and the actual actuator displacement is greater than the second threshold value.

The method may comprise: holding the actuator at its current displacement if: the determined vehicle speed is zero; and the magnitude of the difference between the requested actuator displacement and the actual actuator displacement is less than the first threshold value.

According to a further aspect of the invention, there is provided a vehicle comprising the control system described above, or the system described above.

According to a still further aspect of the invention, there is provided computer software that, when executed, is arranged to perform a method as described above.

According to a yet further aspect of the invention, there is provided a non-transitory, computer-readable storage medium storing instructions thereon that, when executed by one or more electronic processors, causes the one or more electronic processors to carry out the method described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic illustration of a vehicle in accordance with an embodiment of the invention;

FIG. 2 shows a block diagram of a control system such as may be adapted in accordance with an embodiment of the invention;

FIG. 3 shows a flow diagram illustrating a logic flow in accordance with an embodiment of the invention; and

FIG. 4 shows a simplified example of a control system such as may be adapted in accordance with an embodiment of the invention.

### DETAILED DESCRIPTION

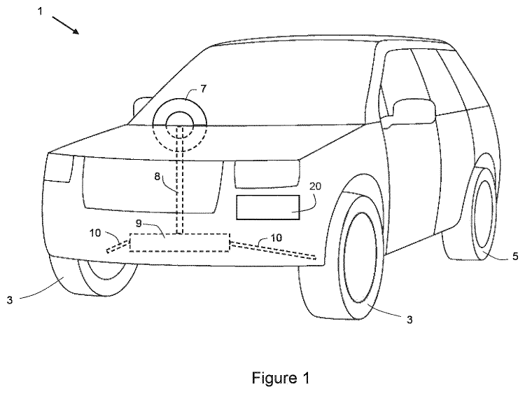

A vehicle 1 in accordance with an embodiment of the present invention is described herein with reference to the accompanying FIG. 1.

The vehicle 1 comprises a pair of front road wheels 3 and a pair of rear road wheels 5, each of which are supported for rotation by a sub-structure (not shown) of the vehicle 1.

The direction in which the front road wheels 3 steer is controlled by movement of a driver operated steering wheel 7 which is connected to a steering rack 9 via a steering column 8. The steering rack 9 is connected by tie rods 10 to each of the front steering knuckles (not shown). Rotation of the steering wheel 7 by a driver causes linear movement of the steering rack 9 which is transmitted to the front steering knuckles by the tie rods 10 to cause the front road wheels' steering angle to vary in response to movement of the steering wheel 7.

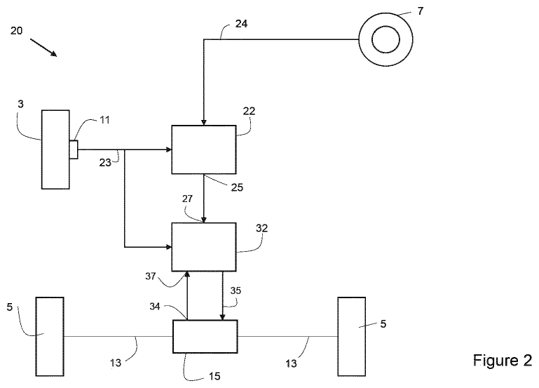

The direction in which the rear road wheels 5 steer is adjusted by an actuator 15 (see FIG. 2). The actuator 15 is controlled by a rear wheel steering control system 20 described below in detail with reference to FIGS. 2 to 4. The actuator 15 comprises a moveable actuator element (not shown) which is driven by an electric motor (not shown). The actuator element is connected via mechanical linkages 13 to rear steering knuckles (not shown). Displacement of the actuator element from a home, or zero mm, position is transmitted to the rear steering knuckles by the mechanical linkages 13 to cause the rear road wheel steering angle to vary in response to movement of the actuator element.

In an alternative embodiment (not shown) the rear road wheel steering angle of each rear wheel 5 may be controlled by a separate actuator, or the actuator 15 may comprise more than one actuator element, one for each rear wheel 5.

Referring to FIG. 2, the rear wheel steering control system 20 comprises a first controller 22 and a second controller 32. The first controller 22 is configured to receive a speed input signal 23 indicative of vehicle speed. The speed input signal 23 may comprise a measurement signal obtained by a wheel rotation speed sensor 11, in which case the controller 22 is configured to determine the vehicle speed from the measurement signal received from the wheel rotation speed sensor 11. In an alternative embodiment, the measurement signal from the wheel rotation speed sensor 11 may be pre-processed such that the speed input signal 23 comprises the vehicle speed as determined by the pre-processor. In each case, the first controller 22 determines the vehicle speed in dependence on the speed input signal 23.

The first controller 22 is also configured to receive a steering input signal 24 indicative of the angular position of the steering wheel 7, and to determine a requested actuator displacement in dependence on the speed input signal 23 and the steering input signal 24. The first controller 22 is configured to output a signal 25 indicative of the requested actuator displacement. The second controller 32 is configured to receive the output signal 25 from the first controller as an input signal 27 indicative of the requested actuator displacement.

The second controller 32 is configured to receive the speed input signal 23 indicative of vehicle speed. As described above with respect to the first controller 22, the speed input signal 23 may comprise a measurement signal obtained by the wheel rotation speed sensor 11, or the measurement signal obtained by the wheel rotation speed sensor 11 may be pre-processed such that the speed input signal 23 comprises the vehicle speed as determined by the pre-processor. In each case, the second controller 32 determines the vehicle speed in dependence on the speed input signal 23.

In an alternative embodiment (not shown), the first controller 22 may be configured to output the vehicle speed as an output signal indicative of vehicle speed, and the second controller 32 may be configured to receive the output signal indicative of vehicle speed from the first controller 22 as an input signal indicative of vehicle speed.

The actuator 15 comprises a displacement sensor (not shown) configured to measure the actual displacement of the actuator element from the home, or zero mm, position. The displacement sensor is configured to output a signal 34 indicative of the actual actuator displacement. The second controller 32 is configured to receive the output signal 34 from the displacement sensor as an input signal 36 indicative of the actual actuator displacement.

The second controller 32 is configured to determine, in dependence on the input signal 27 indicative of the requested actuator displacement and the input signal 36 indicative of the actual actuator displacement, the magnitude of any difference between the requested actuator displacement and the actual actuator displacement.

The second controller 32 is also configured to determine if the magnitude of the difference between the requested actuator displacement and the actual actuator displacement is less than a first threshold value, greater than or equal to the first threshold value, less than or equal to a second threshold value, or greater than the second threshold value. In one embodiment the first threshold valve is 0.05 mm and the second threshold value is 0.3 mm. However, different first and second threshold values to those mentioned above may be used in dependence on the accuracy of the input signal 27 indicative of the requested actuator displacement, safety considerations and subjective steering feel. The first and second thresholds may therefore be tuned to specific vehicle attributes and desired steering feel characteristics.

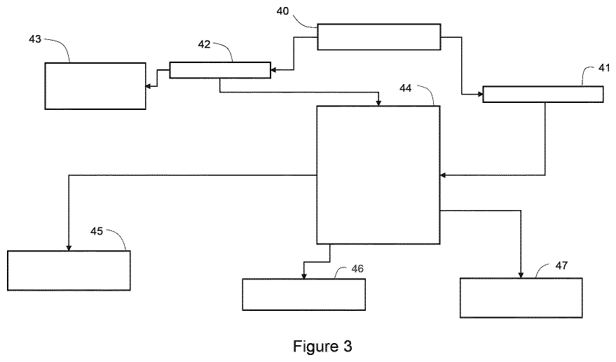

The second controller 32 is configured to output a signal 35 comprising an instruction to move the actuator element, or to hold the actuator element in its current position, in dependence on the vehicle speed and magnitude of the difference between the requested actuator displacement. FIG. 3 shows a flow diagram illustrating the logic flow implemented by the second controller 32.

In a first step 40 the second controller 32 determines if the signal 23 indicative of vehicle speed is available. If the signal 23 indicative of vehicle speed is unavailable the logic flow moves to step 41 where the second controller 32 assumes that the vehicle speed is zero and the logic flow moves to step 44. If the signal 23 indicative of vehicle speed is available, the logic flow moves to step 42 where the second controller determines if the vehicle speed is zero.

If the vehicle speed is not zero, the logic flow moves to step 43 where the second controller 32 outputs a signal 35 comprising an instruction to move the actuator 15 to the requested actuator displacement. If the vehicle speed is zero, the logic flow moves to step 44.

At step 44 the second controller 32 determines if the magnitude of the difference between the requested actuator displacement and the actual actuator displacement is less than the first threshold value, greater than or equal to the first threshold value, less than or equal to the second threshold value, or greater than the second threshold value.

If the magnitude of the difference between the requested actuator displacement and the actual actuator displacement is greater than or equal to the first threshold value and less than or equal to the second threshold value, the logic flow moves to step 45 where the second controller 32 outputs a signal 35 comprising an instruction to move the actuator 15 to the requested actuator displacement such that the difference between the requested actuator displacement and the actual actuator displacement is zero.

If the magnitude of the difference between the requested actuator displacement and the actual actuator displacement is less than the first threshold value, the logic flow moves to step 46 where the second controller 32 outputs a signal 35 comprising an instruction to hold the actuator at its current displacement.

If the magnitude of the difference between the requested actuator displacement and the actual actuator displacement is greater than the second threshold value, the logic flow moves to step 47 where the second controller 32 outputs a signal 35 comprising an instruction to hold the actuator at its current displacement.

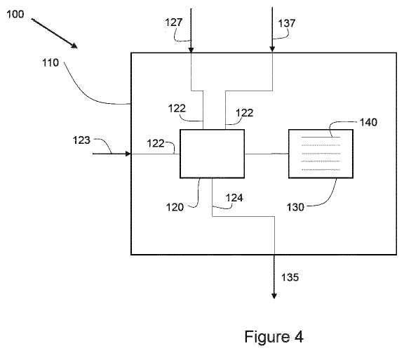

With reference to FIG. 4, there is illustrated a simplified example of a control system 100 such as may be adapted to implement the method of FIG. 3 described above. The control system 100 comprises one or more controllers 110 and is configured to receive a first input signal 123 indicative of vehicle speed and determine a vehicle speed in dependence on the first input signal 123; receive a second input signal 127 indicative of a requested actuator displacement; receive a third input signal 137 indicative of an actual actuator displacement; determine, in dependence on the second input signal 127 and the third input signal 137, the magnitude of the difference between the requested actuator displacement and the actual actuator displacement; and output a signal 135 comprising an instruction to move the actuator to a position in which the difference between the requested actuator displacement and the actual actuator displacement is zero if the determined vehicle speed is zero, and the magnitude of the difference between the requested actuator displacement and the actual actuator displacement is determined to be greater than or equal to a first threshold value and less than or equal to a second threshold value.

It is to be understood that the or each controller 110 can comprise a control unit or computational device having one or more electronic processors (e.g., a microprocessor, a microcontroller, an application specific integrated circuit (ASIC), etc.), and may comprise a single control unit or computational device, or alternatively different functions of the or each controller 110 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller 110 to implement the control techniques described herein (including some or all of the functionality required for the method described herein). The set of instructions could be embedded in said one or more electronic processors of the controller 110; or alternatively, the set of instructions could be provided as software to be executed in the controller 110. A first controller or control unit may be implemented in software run on one or more processors. One or more other controllers or control units may be implemented in software run on one or more processors, optionally the same one or more processors as the first controller or control unit. Other arrangements are also useful.

In the example illustrated in FIG. 4, the or each controller 110 comprises at least one electronic processor 120 having one or more electrical input(s) 122 for receiving one or more of the first 123, second 127, and/or third 137 input signals, and one or more electrical output(s) 124 for outputting one or more output signals 135. The or each controller 110 further comprises at least one memory device 130 electrically coupled to the at least one electronic processor 120 and having instructions 140 stored therein. The at least one electronic processor 120 is configured to access the at least one memory device 130 and execute the instructions 140 thereon so as to determine the vehicle speed; determine the magnitude of the difference between the requested actuator displacement and the actual actuator displacement; and output the signal 135 comprising the instruction in dependence on the vehicle speed and the magnitude of the difference between the requested actuator displacement and the actual actuator displacement.

The, or each, electronic processor 120 may comprise any suitable electronic processor (e.g., a microprocessor, a microcontroller, an ASIC, etc.) that is configured to execute electronic instructions. The, or each, electronic memory device 130 may comprise any suitable memory device and may store a variety of data, information, threshold value(s), lookup tables or other data structures, and/or instructions therein or thereon. In an embodiment, the memory device 130 has information and instructions for software, firmware, programs, algorithms, scripts, applications, etc. stored therein or thereon that may govern all or part of the methodology described herein. The processor, or each, electronic processor 120 may access the memory device 130 and execute and/or use that or those instructions and information to carry out or perform some or all of the functionality and methodology describe herein.

The at least one memory device 130 may comprise a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

Example controllers 110 have been described comprising at least one electronic processor 120 configured to execute electronic instructions stored within at least one memory device 130, which when executed causes the electronic processor(s) 120 to carry out the method as hereinbefore described. However, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc.

It will be appreciated that various changes and modifications can be made to the present invention without departing from the scope of the present application.

1-13. (canceled)

14. A control system for controlling an actuator of a rear wheel steering system of a vehicle, the control system comprising one or more controllers, the control system configured to:
receive a first input signal indicative of vehicle speed and determine a vehicle speed in dependence on the first input signal;
receive a second input signal indicative of a requested actuator displacement;
receive a third input signal indicative of an actual actuator displacement;
determine, in dependence on the second input signal and the third input signal, the magnitude of the difference between the requested actuator displacement and the actual actuator displacement; and
output a signal comprising an instruction to move the actuator to a position in which the difference between the requested actuator displacement and the actual actuator displacement is zero if:
the determined vehicle speed is zero; and
the magnitude of the difference between the requested actuator displacement and the actual actuator displacement is determined to be greater than or equal to a first threshold value and less than or equal to a second threshold value.

15. The control system of claim 14, wherein the one or more controllers collectively comprise:
at least one electronic processor having an electrical input for receiving one or more of the first, second, and/or third input signals; and
at least one memory device electrically coupled to the at least one electronic processor and having instructions stored therein;
and wherein the at least one electronic processor is configured to access the at least one memory device and execute the instructions thereon so as to:
determine the vehicle speed;
determine the magnitude of the difference between the requested actuator displacement and the actual actuator displacement; and
output the signal comprising the instruction in dependence on the vehicle speed and the magnitude of the difference between the requested actuator displacement and the actual actuator displacement.

16. The control system of claim 14, configured to determine a vehicle speed equal to zero if the first input signal is unavailable.

17. The control system of claim 14, configured to:
output a signal comprising an instruction to hold the actuator at its current displacement if:
the determined vehicle speed is zero; and
the magnitude of the difference between the requested actuator displacement and the actual actuator displacement is determined to be greater than the second threshold value.

18. The control system of claim 14, configured to:
output a signal comprising an instruction to hold the actuator at its current displacement if:
the determined vehicle speed is zero; and
the magnitude of the difference between the requested actuator displacement and the actual actuator displacement is determined to be less than the first threshold value.

19. A vehicle comprising the control system of claim 14.

20. A system, comprising:
an actuator having a moveable actuator element, wherein displacement of the actuator element from a home position determines a steering position of a rear wheel steering system; and
the control system of claim 14, including at least a first controller, herein the at least a first controller is arranged to output a signal for causing movement of the actuator element, wherein the actuator is configured to receive the signal and move the actuator element in dependence on the signal.

21. A vehicle comprising the system of claim 20.

22. A method for controlling an actuator of a rear wheel steering system of a vehicle, the method comprising:
receiving a signal indicative of vehicle speed and determining a vehicle speed in dependence on the signal indicative of vehicle speed;
receiving a displacement request signal indicative of a requested actuator displacement;
receiving an actuator displacement signal indicative of an actual actuator displacement;
determining, in dependence on the displacement request signal and the actuator displacement signal, the magnitude of the difference between the requested actuator displacement and the actual actuator displacement; and
moving the actuator until the difference between the requested actuator displacement and the actual actuator displacement is zero if:
if the determined vehicle speed is zero; and
the magnitude of the difference between the requested actuator displacement and the actual actuator displacement is greater than or equal to a first threshold value and less than or equal to a second threshold value.

23. The method of claim 22, comprising determining that the vehicle speed is equal zero if the first input signal is unavailable.

24. The method of claim 22, comprising:
holding the actuator at its current displacement if: the determined vehicle speed is zero; and
the magnitude of the difference between the requested actuator displacement and the actual actuator displacement is greater than the second threshold value.

25. The method of claim 22, comprising:
holding the actuator at its current displacement if:
the determined vehicle speed is zero; and
the magnitude of the difference between the requested actuator displacement and the actual actuator displacement is less than the first threshold value.

26. A non-transitory, computer-readable storage medium storing instructions thereon that, when executed by one or more electronic processors, causes the one or more electronic processors to carry out the method of claim 22.
